(19) United States
(12) Patent Application Publication
(10) Pub. No.: US 2026/0149946 A1
(43) Pub. Date: May 28, 2026

(54) ZONE-SPECIFIC CONFIGURATION

(71) Applicant: QUALCOMM Incorporated, San Diego, CA (US)

(72) Inventors: Ahmed BEDEWY, Hillsborough, NJ (US); Navid ABEDINI, Basking Ridge, NJ (US); Jianghong LUO, Skillman, NJ (US)

(21) Appl. No.: 18/961,635

(22) Filed: Nov. 27, 2024

(51) Int. Cl. H04W 4/021; H04L 41/16; H04L 47/283; H04W 4/80

(52) U.S. Cl. CPC H04W 4/021; H04L 41/16; H04L 47/283; H04W 4/80

(57) ABSTRACT

Various aspects of the present disclosure generally relate to wireless communication. In some aspects, a user equipment (UE) may select a zone configuration for a zone that is specific to where signal measurements satisfy a signal threshold, a signal timing satisfies a timing threshold, UE sensing measurements satisfy a sensing threshold, a UE mobility speed satisfies a speed threshold, a UE mobility direction satisfies a direction characteristic, or a signal angle of arrival satisfies an angle characteristic. The UE may communicate using the zone configuration based at least in part on a determination that the UE is located in the zone. Numerous other aspects are described.

### FIELD OF THE DISCLOSURE

Aspects of the present disclosure generally relate to wireless communication and specifically relate to techniques, apparatuses, and methods associated with configurations that are zone-specific.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by a user equipment (UE). The method may include selecting a zone configuration for a zone that is specific to where signal measurements satisfy a signal threshold or where a signal timing satisfies a timing threshold. The method may include communicating using the zone configuration based at least in part on a determination that the UE is located in the zone.

Some aspects described herein relate to a method of wireless communication performed by a UE. The method may include selecting a zone configuration for a zone that is specific to where: UE sensing measurements satisfy a sensing threshold, a UE mobility speed satisfies a speed threshold, a UE mobility direction satisfies a direction characteristic, or a signal angle of arrival satisfies an angle characteristic. The method may include communicating using the zone configuration based at least in part on a determination that the UE is in the zone.

Some aspects described herein relate to a method of wireless communication performed by a UE. The method may include receiving zone determination information that is associated with identification of a zone for which a zone configuration applies. The method may include communicating a message using the zone configuration, based at least in part on a determination, using the zone determination information, that the UE is located in the zone.

Some aspects described herein relate to an apparatus for wireless communication at a UE. The apparatus may include one or more memories comprising processor-executable instructions and one or more processors coupled to the one or more memories. The one or more processors may be configured to execute the processor-executable instructions and cause the apparatus to select a zone configuration for a zone that is specific to where signal measurements satisfy a signal threshold or where a signal timing satisfies a timing threshold. The one or more processors may be configured to execute the processor-executable instructions and cause the apparatus to communicate using the zone configuration based at least in part on a determination that the UE is located in the zone.

Some aspects described herein relate to an apparatus for wireless communication at a UE. The apparatus may include one or more memories comprising processor-executable instructions and one or more processors coupled to the one or more memories. The one or more processors may be configured to execute the processor-executable instructions and cause the apparatus to select a zone configuration for a zone that is specific to where: UE sensing measurements satisfy a sensing threshold, a UE mobility speed satisfies a speed threshold, a UE mobility direction satisfies a direction characteristic, or a signal angle of arrival satisfies an angle characteristic. The one or more processors may be configured to execute the processor-executable instructions and cause the apparatus to communicate using the zone configuration based at least in part on a determination that the UE is in the zone.

Some aspects described herein relate to an apparatus for wireless communication at a UE. The apparatus may include one or more memories comprising processor-executable instructions and one or more processors coupled to the one or more memories. The one or more processors may be configured to execute the processor-executable instructions and cause the apparatus to receive zone determination information that is associated with identification of a zone for which a zone configuration applies. The one or more processors may be configured to execute the processor-executable instructions and cause the apparatus to communicate a message using the zone configuration, based at least in part on a determination, using the zone determination information, that the UE is located in the zone.

Some aspects described herein relate to a non-transitory computer-readable medium that stores a set of instructions for wireless communication by a UE. The set of instructions, when executed by one or more processors of the UE, may cause the UE to select a zone configuration for a zone that is specific to where signal measurements satisfy a signal threshold or where a signal timing satisfies a timing threshold. The set of instructions, when executed by one or more processors of the UE, may cause the UE to communicate using the zone configuration based at least in part on a determination that the UE is located in the zone.

Some aspects described herein relate to a non-transitory computer-readable medium that stores a set of instructions for wireless communication by a UE. The set of instructions, when executed by one or more processors of the UE, may cause the UE to select a zone configuration for a zone that is specific to where: UE sensing measurements satisfy a sensing threshold, a UE mobility speed satisfies a speed threshold, a UE mobility direction satisfies a direction characteristic, or a signal angle of arrival satisfies an angle characteristic. The set of instructions, when executed by one or more processors of the UE, may cause the UE to communicate using the zone configuration based at least in part on a determination that the UE is in the zone.

Some aspects described herein relate to a non-transitory computer-readable medium that stores a set of instructions for wireless communication by a UE. The set of instructions, when executed by one or more processors of the UE, may cause the UE to receive zone determination information that is associated with identification of a zone for which a zone configuration applies. The set of instructions, when executed by one or more processors of the UE, may cause the UE to communicate a message using the zone configuration, based at least in part on a determination, using the zone determination information, that the UE is located in the zone.

Some aspects described herein relate to an apparatus for wireless communication. The apparatus may include means for selecting a zone configuration for a zone that is specific to where signal measurements satisfy a signal threshold or where a signal timing satisfies a timing threshold. The apparatus may include means for communicating using the zone configuration based at least in part on a determination that the apparatus is located in the zone.

Some aspects described herein relate to an apparatus for wireless communication. The apparatus may include means for selecting a zone configuration for a zone that is specific to where: sensing measurements satisfy a sensing threshold, a mobility speed satisfies a speed threshold, a mobility direction satisfies a direction characteristic, or a signal angle of arrival satisfies an angle characteristic. The apparatus may include means for communicating using the zone configuration based at least in part on a determination that the apparatus is in the zone.

Some aspects described herein relate to an apparatus for wireless communication. The apparatus may include means for receiving zone determination information that is associated with identification of a zone for which a zone configuration applies. The apparatus may include means for communicating a message using the zone configuration, based at least in part on a determination, using the zone determination information, that the apparatus is located in the zone.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating examples of channel state information reference signal beam management procedures, in accordance with the present disclosure.

FIG. 4 is a diagram illustrating an example associated with zone configurations, in accordance with the present disclosure.

FIG. 5 is a diagram illustrating an example associated with zone-specific configurations, in accordance with the present disclosure.

FIG. 6 is a diagram illustrating an example associated with zone-specific configurations, in accordance with the present disclosure.

FIG. 7 is a diagram illustrating an example associated with determining a zone, in accordance with the present disclosure.

FIG. 8 is a diagram illustrating an example of using zone determination information, in accordance with the present disclosure.

FIG. 9 is a flowchart of an example method of wireless communication.

FIG. 10 is a flowchart of an example method of wireless communication.

FIG. 11 is a flowchart of an example method of wireless communication.

FIG. 12 is a diagram of an example apparatus for wireless communication, in accordance with the present disclosure.

FIG. 13 is a diagram illustrating an example of an implementation of code and circuitry for a communications device, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A user equipment (UE) may use a beam configuration (e.g., direction, weights for beamforming) to configure a receive beam or a transmit beam for communications. A UE may also monitor for broadcasts according to a broadcast configuration (e.g., periodicity or timing of broadcasts) of a network entity. A beam configuration or a broadcast configuration may apply to a specific beam or a specific cell. In some scenarios, rather than the beam configuration or the broadcast configuration being cell-specific or beam-specific, the configuration may be specific to a zone. A UE may apply specific configuration parameters or perform a specific action in a zone, but not outside of the zone. For example, for a UE in a zone, the UE may use a specific beam, use a specific monitoring scheme, deprioritize (or skip) searching a group of cells or beams, (de)prioritize (or skip) measuring or reporting a group of cells or beams, (de)prioritize (or avoid) selecting a cell or beam for camping or connection, and/or select a specific random access channel (RACH) configuration. In some aspects, a zone may be beam-based, geographic-location-based, or height-based. However, a geographic location, beam, or height-based definition for a zone may have limitations or may not address specific characteristics of a group of UEs. Different UEs in the same location may benefit from different beam configurations or broadcast configurations. Accordingly, a beam configuration or a broadcast configuration may not be optimal for one or more UEs, resulting in wasted power, wasted signaling resources, increased latency, and/or reduced throughput.

Various aspects relate generally to UE configuration. Some aspects more specifically relate to defining a zone that is defined based at least in part on properties or conditions other than geographic location, beam, or height. For example, a zone may be specific to where signal measurements satisfy a signal threshold. The measurements may be Bluetooth® (BT) protocol measurements, wireless local area network (WLAN) measurements, or cellular measurements. A zone may be specific to where a signal timing satisfies a timing threshold, such as downlink receive timing, uplink transmit timing, a time difference of arrival (TDoA), and/or an estimated round trip time (RTT).

Particular aspects of the subject matter described in this disclosure can be implemented to realize one or more of the following potential advantages. By using a zone-specific configuration, a UE may use a more optimal beam configuration or monitoring scheme (for a broadcast configuration) to improve communications, which increases throughput and reduces latency.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

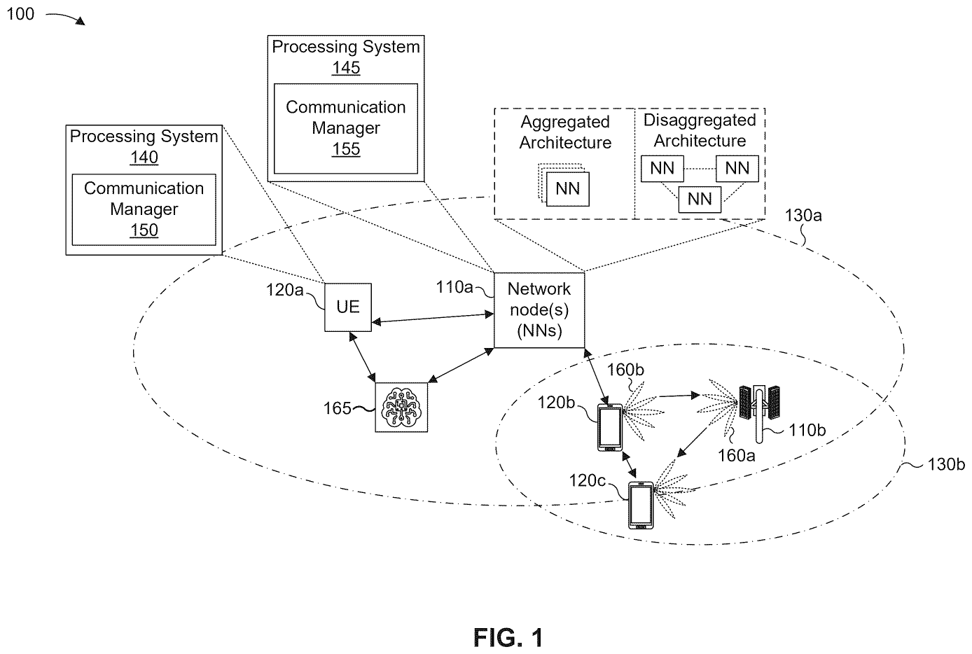

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145 with a communication manager 155) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

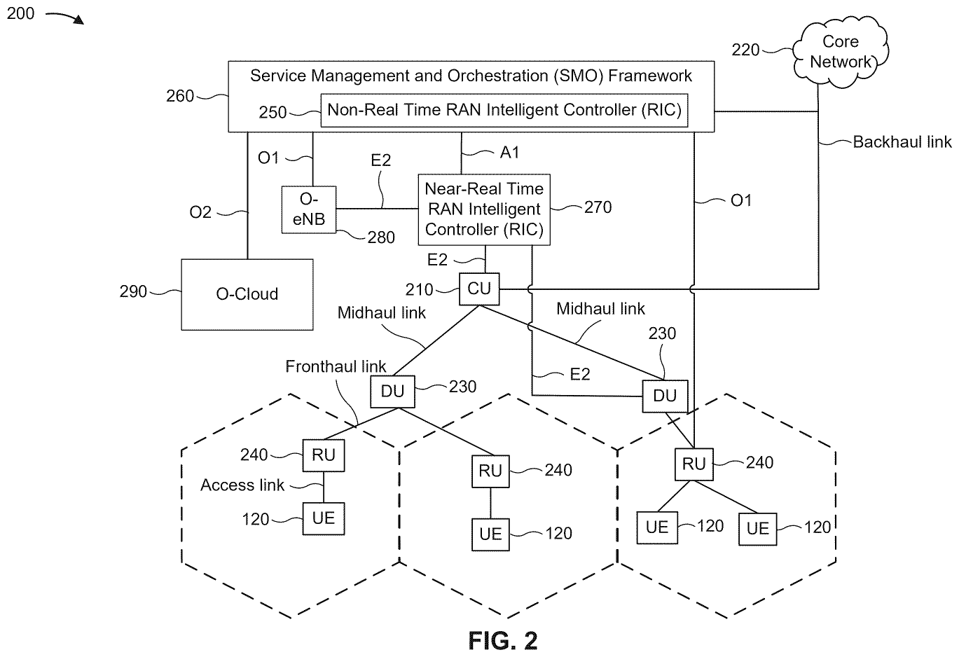

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a RACH operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, a UE (e.g., a UE 120) may include a communication manager 150. As described in more detail elsewhere herein, the communication manager 150 may select a zone configuration for a zone that is specific to where signal measurements satisfy a signal threshold or where a signal timing satisfies a timing threshold; and communicate using the zone configuration based at least in part on a determination that the UE is located in the zone.

In some aspects, the communication manager 150 may select a zone configuration for a zone that is specific to where: UE sensing measurements satisfy a sensing threshold, a UE mobility speed satisfies a speed threshold, a UE mobility direction satisfies a direction characteristic, or a signal angle of arrival satisfies an angle characteristic; and communicate using the zone configuration based at least in part on a determination that the UE is in the zone.

In some aspects, the communication manager 150 may receive zone determination information that is associated with identification of a zone for which a zone configuration applies; and communicate a message using the zone configuration, based at least in part on a determination, using the zone determination information, that the UE is located in the zone. Additionally, or alternatively, the communication manager 150 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

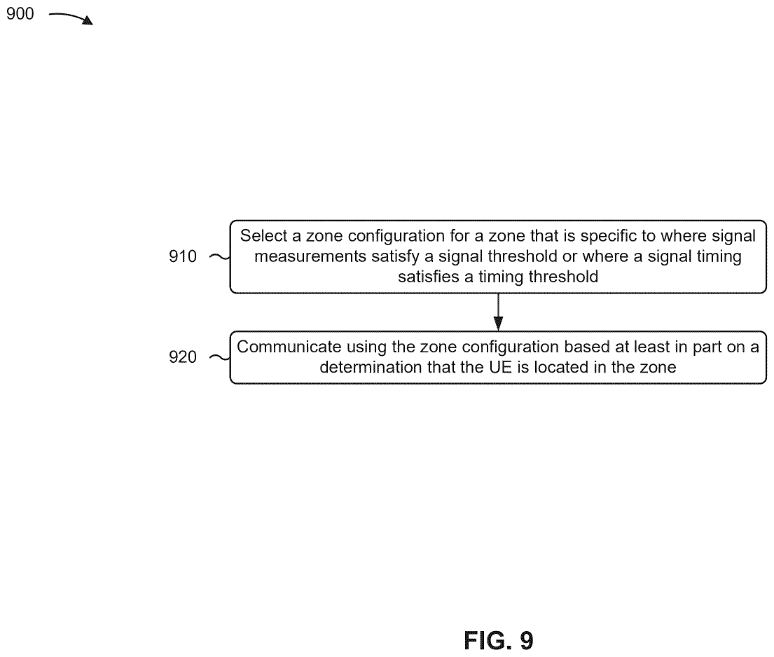

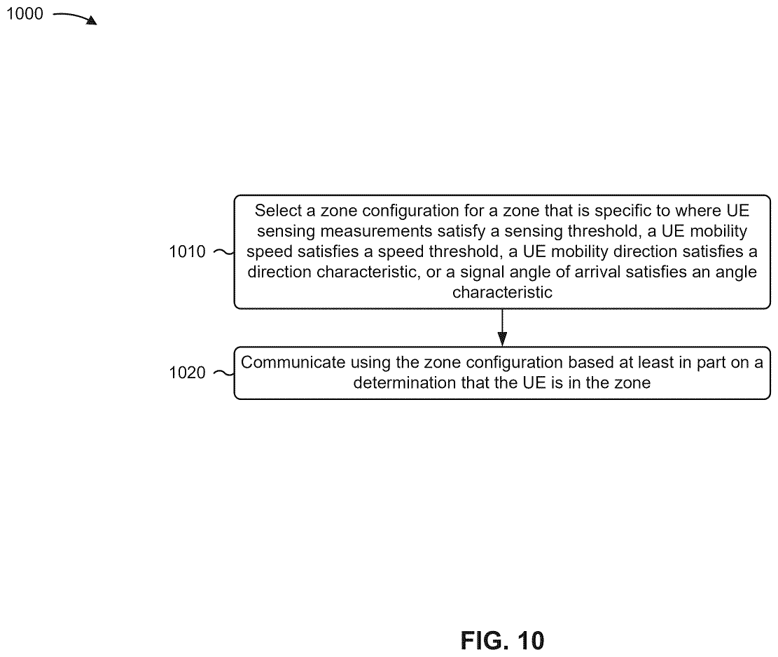

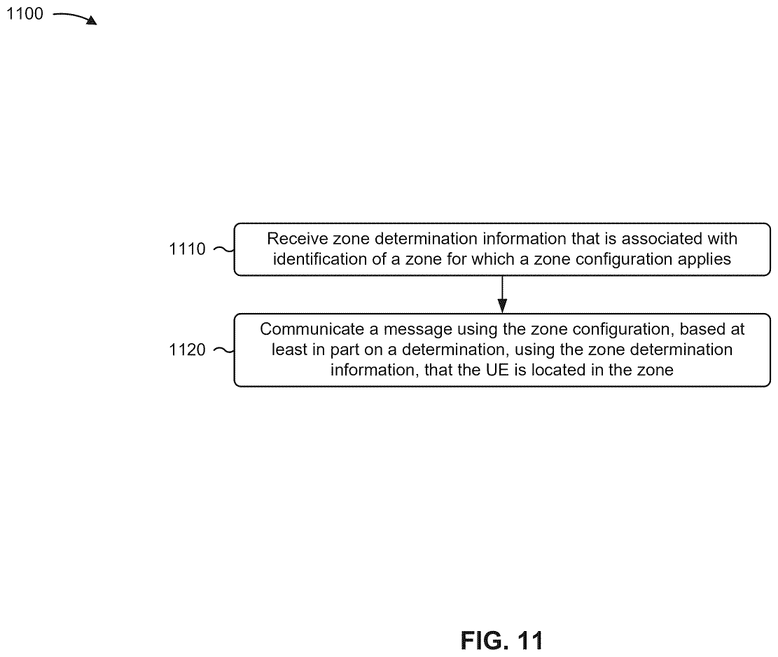

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with zone configurations, as described in more detail elsewhere herein. For example, the processing system 145 of the network node 110, the processing system 140 of the UE 120, the CU 210, the DU 230, or the RU 240 may perform or direct operations of, for example, method 900 of FIG. 9, method 1000 of FIG. 10, method 1100 of FIG. 11, or other methods as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform method 900 of FIG. 9, method 1000 of FIG. 10, method 1100 of FIG. 11, or other processes as described herein. In some examples, executing instructions may include running the instructions, converting the instructions, compiling the instructions, and/or interpreting the instructions, among other examples.

In some aspects, a UE (e.g. a UE 120) includes means for selecting a zone configuration for a zone that is specific to where signal measurements satisfy a signal threshold or where a signal timing satisfies a timing threshold; and/or means for communicating using the zone configuration based at least in part on a determination that the UE is located in the zone.

In some aspects, the UE includes means for selecting a zone configuration for a zone that is specific to where: UE sensing measurements satisfy a sensing threshold, a UE mobility speed satisfies a speed threshold, a UE mobility direction satisfies a direction characteristic, or a signal angle of arrival satisfies an angle characteristic; and/or means for communicating using the zone configuration based at least in part on a determination that the UE is in the zone.

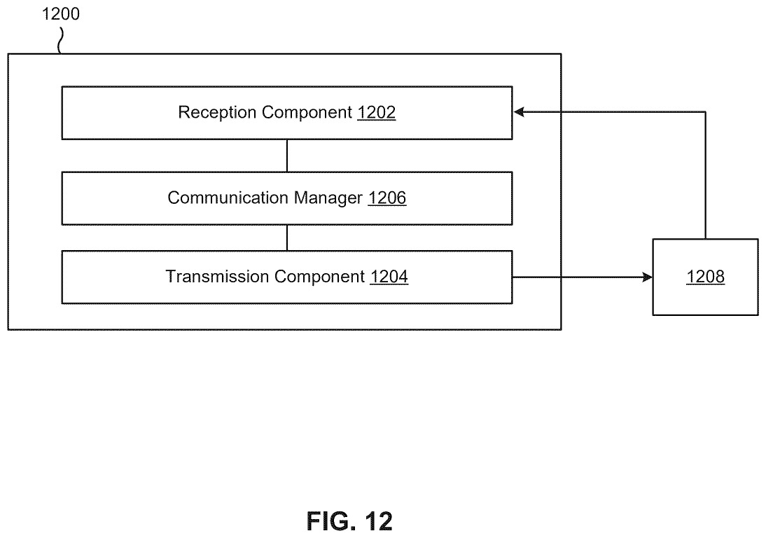

In some aspects, the UE includes means for receiving zone determination information that is associated with identification of a zone for which a zone configuration applies; and/or means for communicating a message using the zone configuration, based at least in part on a determination, using the zone determination information, that the UE is located in the zone. The means for the UE to perform operations described herein may include, for example, one or more of communication manager 150, processing system 140, a radio, one or more RF chains, one or more transceivers, one or more antennas, one or more modems, a reception component (for example, reception component 1202 depicted and described in connection with FIG. 12), and/or a transmission component (for example, transmission component 1204 depicted and described in connection with FIG. 12), among other examples.

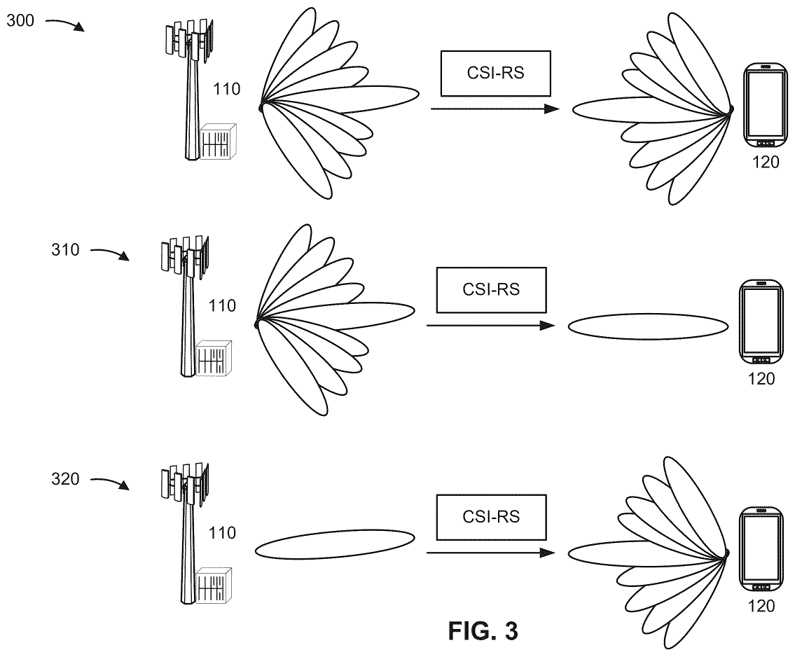

FIG. 3 is a diagram illustrating examples 300, 310, and 320 of CSI-RS beam management procedures, in accordance with the present disclosure. As shown in FIG. 3, examples 300, 310, and 320 include a UE 120 in communication with a network node 110 in a wireless network (e.g., wireless network 100). However, the devices shown in FIG. 3 are provided as examples, and the wireless network may support communication and beam management between other devices (e.g., between a UE 120 and a network node 110 or transmit receive point (TRP), between a mobile termination node and a control node, between an integrated access and backhaul (IAB) child node and an IAB parent node, and/or between a scheduled node and a scheduling node). In some aspects, the UE 120 and the network node 110 may be in a connected state (e.g., an RRC connected state).

As shown in FIG. 3, example 300 may include a network node 110 (e.g., one or more network node devices such as an RU, a DU, and/or a CU, among other examples) and a UE 120 communicating to perform beam management using CSI-RSs. Example 300 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 3 and example 300, CSI-RSs may be configured to be transmitted from the network node 110 to the UE 120. The CSI-RSs may be configured to be periodic (e.g., using RRC signaling), semi-persistent (e.g., using media access control (MAC) control element (MAC-CE) signaling), and/or aperiodic (e.g., using DCI).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (e.g., with repetitions) each CSI-RS at multiple times within the same RS resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 300 has been described in connection with CSI-RSs, the first beam management process may also use SSBs for beam management in a similar manner as described above.

As shown in FIG. 3, example 310 may include a network node 110 and a UE 120 communicating to perform beam management using CSI-RSs. Example 310 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 3 and example 310, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 3, example 320 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 3 and example 320, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

A network entity may use a beam-specific broadcast configuration for broadcast signals, such as SSBs, remaining minimum system information (RMSI), RACH, and/or pages. The beam-specific broadcast configuration may be uniform across different beams. However, the spatial coverage may not be uniform, and/or a cell may want to treat different spatial regions differently. A broadcast configuration may account for low-density directions, high-density directions, blocked directions, or directions with reduced signal strength or signal-to-noise ratio (SNR). For example, a broadcast configuration may adopt a network energy savings (NES) approach for a low-density direction. The broadcast configuration may balance the NES feature and the impact to the UEs.

In some aspects, a broadcast configuration for an SSB may indicate a periodicity, an on-demand SSB, or a dynamic resource scheduling (DRS). A broadcast configuration for an RMSI may indicate a periodicity, an on-demand system information (SI). A broadcast configuration for a RACH may indicate a periodicity or an SSB to RACH occasions (RO). A broadcast information for paging may indicate no paging support or a beam-specific paging occasion (PO) selection. For example, a broadcast configuration may indicate a uniform SSB sweep, different periodicities for different SSBs, a light/on-demand SSB only in some directions, or a light/on-demand SSB only in some directions and some periods. In another example, a beam-specific broadcast configuration may indicate a higher target receive power and/or a faster power ramping. In some aspects, a broadcast configuration may be cell-specific.

A network entity may transmit paging messages in a PO. If some directions are sparsely populated, it may be less efficient to transmit in those directions in each PO. Separate POs within a discontinuous reception (DRX) cycle may transmit different sets of directions.

As indicated above, FIG. 3 is provided as an example of beam management procedures. Other examples of beam management procedures may differ from what is described with respect to FIG. 3. For example, the UE 120 and the network node 110 may perform the third beam management procedure before performing the second beam management procedure, and/or the UE 120 and the network node 110 may perform a similar beam management procedure to select a UE transmit beam.

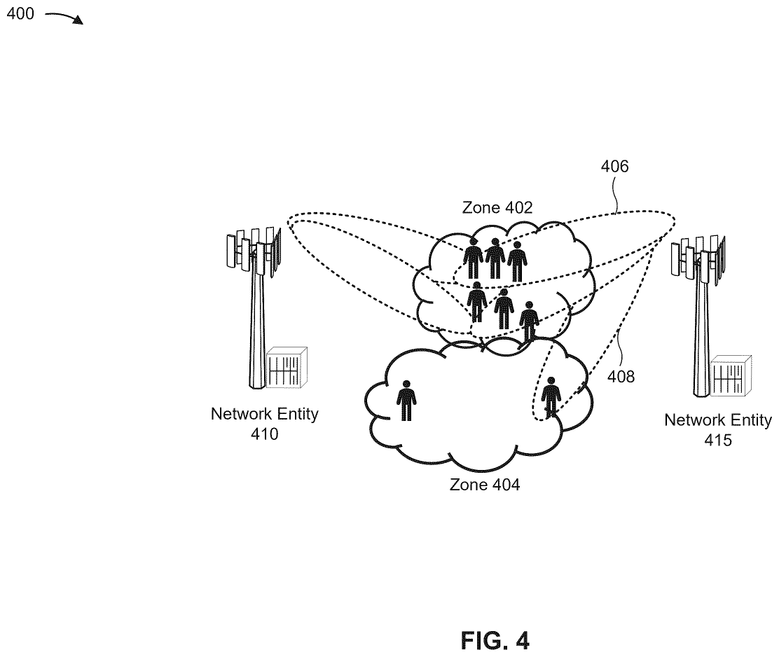

FIG. 4 is a diagram illustrating an example 400 associated with zone configurations, in accordance with the present disclosure.

In some scenarios, rather than a beam configuration or a broadcast configuration being cell-specific or beam-specific, the configuration may be specific to a zone. A UE may apply specific configuration parameters or perform a specific action in a zone, but not outside of the zone. For example, for a UE in a zone, the UE may use a specific beam, use a specific monitoring scheme for broadcasts, deprioritize (or skip) searching a group of cells or beams, (de)prioritize (or skip) measuring or reporting a group of cells or beams, (de)prioritize (or avoid) selecting a cell or beam for camping or connection, and/or select a specific RACH configuration. A UE in the zone may already support a configuration that is cell-specific, RSRP-specific, or feature-specific. In other examples, the UE may use a specific paging-related configuration, apply an open-loop coarse time or power adjustment, map a hashed identifier (ID) to a full cell ID, use a specific time division duplex (TDD) or subband full duplex (SBFD) configuration, and/or report zone information to the network entity (including zone change indication).

In some aspects, a zone may be beam-based, geographic-location-based, or height-based. Example 400 shows beams of a network entity 410 and a network entity 415 that are directed to UEs in two zones 402 and 404 that are specified by geographic location. Beam 406 may have a zone-specific beam configuration for zone 402, and beam 408 may have a zone-specific beam configuration for zone 404. The UEs may operate differently based on the geographic zone in which each UE is determined to be located.

However, a geographic location, beam, or height-based definition for a zone may have limitations or may not address specific characteristics of a group of UEs. Different UEs in the same location may benefit from different beam configurations or broadcast configurations. Accordingly, a beam configuration or a broadcast configuration may not be optimal for one or more UEs, resulting in wasted power, wasted signaling resources, increased latency, and/or reduced throughput.

As indicated above, FIG. 4 is provided as an example. Other examples may differ from what is described with respect to FIG. 4.

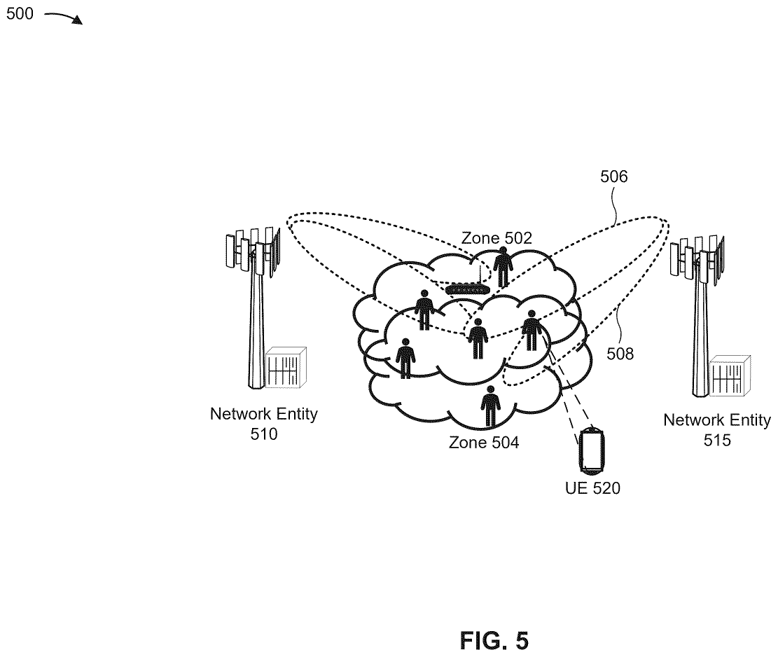

FIG. 5 is a diagram illustrating an example 500 associated with zone-specific configurations, in accordance with the present disclosure. As shown in FIG. 5, a network entity 510 (e.g., a network node 120) and a UE 520 (e.g., a UE 120) may communicate with one another via a wireless network (e.g., wireless communication network 100).

According to various aspects described herein, a zone may be defined based at least in part on properties or conditions other than geographic location, beam, or height. For example, a zone may be specific to where signal measurements satisfy a signal threshold. The measurements may be BT protocol measurements, WLAN measurements, or cellular (3GPP) measurements. A zone may be specific to where a signal timing satisfies a timing threshold. A zone may be defined or specified by other properties. By using a zone-specific configuration, a UE may use a more optimal beam configuration or monitoring scheme (for a broadcast configuration) to improve communications, which increases throughput and reduces latency.

Example 500 shows beams from network entity 510 and network entity 515 toward UEs within multiple zones. In an example of a zone defined by properties other than location, beam, or height, zone 502 includes UEs that are closer to a Wi-Fi access point (AP), where the WLAN measurements satisfy (e.g., exceed) a WLAN signal strength threshold. Zone 504 includes UEs that are further from the Wi-Fi AP or more blocked, where the WLAN measurements do not satisfy the WLAN signal strength threshold. Beam 506 may have a zone-specific configuration for zone 502, and beam 508 may have a zone-specific configuration for zone 504. The UE 520 may determine to which zone the UE 520 belongs based at least in part on a comparison of its WLAN measurements to the WLAN signal strength threshold.

In some aspects, a zone may be specified according to other properties. For example, a zone may be specified by a timing. The timing may include downlink receive timing, uplink transmit timing, a TDoA, and/or an estimated RTT. In some aspects, a zone may be specific to where UE sensing measurements satisfy a sensing threshold (sensing values equal to or greater than a minimum sensing value) or where a UE mobility speed satisfies a speed threshold (e.g., greater than or equal to a minimum speed). In some aspects, a zone may be specific to where a UE mobility direction satisfies a direction characteristic (e.g., is within a range of directions or within a certain number of degrees of a beam direction). In some aspects, a zone may be specific to where a signal angle of arrival (AoA) or an angle of departure (AoD) satisfies an angle characteristic (e.g., AoA within an AoA range or AoD within an AoD range). In some aspects, a zone may be specific to where UEs are in a particular mobility state (e.g., stationary, certain amount of movement). In some aspects, a zone may be based at least in part on a time of day (or hour/day to address dynamic changes such as dynamic beam activation). Other extensions for a zone consideration may include UE features, UE class, subscription, and/or a UE capability.

In some aspects, a network entity 515 (e.g., for a BT network or a WLAN network entity) may indicate one or more zones to the UE 520 in zone information. When the UE 520 detects a specific BT device or Wi-Fi network, the UE 520 may inform the network entity 515 about this detection (e.g., indicate measurements or network information). The network entity 515 may then determine the location or the zone of the UE 520 and begin pushing zone-specific configurations to the UE that are specific to the zone of the UE 520. The network entity 515 may transmit zone-specific configurations in the zone information. The zone-specific configurations may involve, for example, the UE 520 deprioritizing measurements, skipping measurements, or reporting measurements for a group of cells or beams associated with the zone. The zone-specific configurations may include, for example, deprioritizing or avoiding cell or beam selection for camping or connection purposes.

The network entity 515 may acquire the locations of BT devices or WLAN devices from previous reports provided by UEs. Additionally, the UE 520 may obtain or derive the optimal configuration for zones from past reports.

As indicated above, FIG. 5 is provided as an example. Other examples may differ from what is described with respect to FIG. 5.

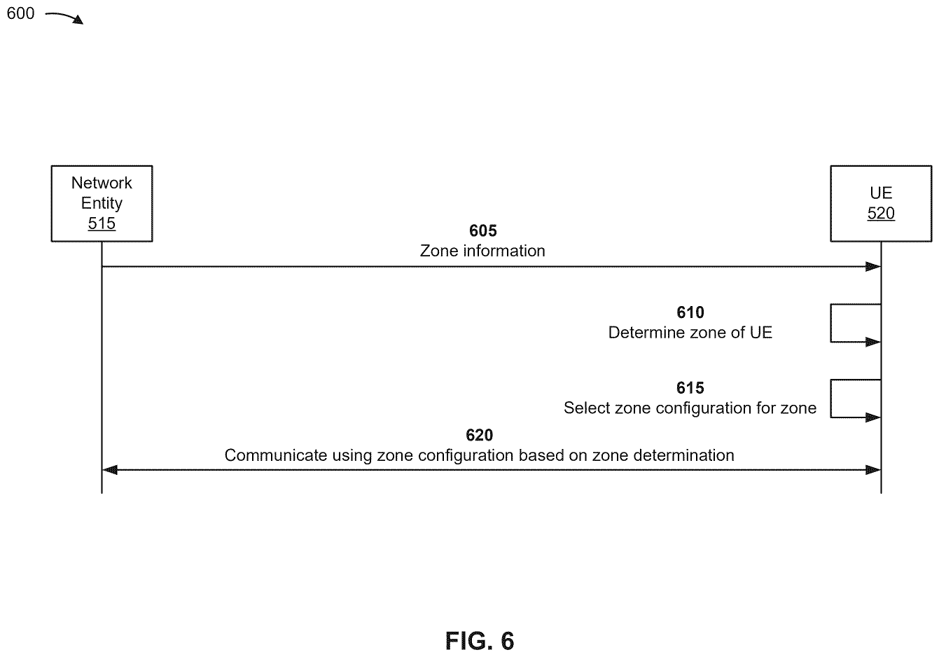

FIG. 6 is a diagram illustrating an example 600 associated with zone-specific configurations, in accordance with the present disclosure. Example 600 may show signaling for the network entity 515 and the UE 520 of example 500.

As shown by reference number 605, the network entity 515 may transmit zone information, which may define zones and include or indicate zone configurations (zone-specific configurations). The UE 520 may operate in a certain way using a zone configuration.

As shown by reference number 610, the UE 520 may determine the zone of the UE 520. The zone (e.g., zone 502) may be defined in a way other than by geographic location, beam, or height, such as described in connection with FIG. 5. In some aspects, the UE 520 may determine the zone from an explicit indication of the zone in the zone information. In some aspects, the zone information may include an implicit indication of a zone, or a rule (e.g., condition) for the UE 520 to use to determine the zone.

As shown by reference number 615, the UE 520 may select the zone configuration for the zone (zone-specific configuration). There may be a one-to-one zone-to-zone configuration mapping. There may be multiple zone configurations for a zone, and the UE 520 may select the zone configuration based at least in part on an explicit indication, an explicit mapping in a configuration, or an implicit indication (e.g., rule). In some aspects, the UE 520 may select a zone based at least in part on UE sensing measurements satisfying a sensing threshold, a UE mobility speed satisfying a speed threshold, a UE mobility direction satisfying a direction characteristic, or a signal angle of arrival satisfying an angle characteristic. In some aspects, the UE 520 may select a zone based at least in part on a UE feature satisfying a feature characteristic, a UE class matching a UE class characteristic, a UE subscription matching a subscription characteristic, and/or a UE capability satisfying a UE capability characteristic.

As shown by reference number 620, the network entity 515 may communicate (e.g., transmit or receive messages) with the UE 520 using the zone configuration, based at least in part on the zone determination. The zone configuration may correspond to the determined zone. If no zone is determined, there may be a default configuration. In some aspects, the UE 520 may be preconfigured for one or more zones.

As indicated above, FIG. 6 is provided as an example. Other examples may differ from what is described with respect to FIG. 6.

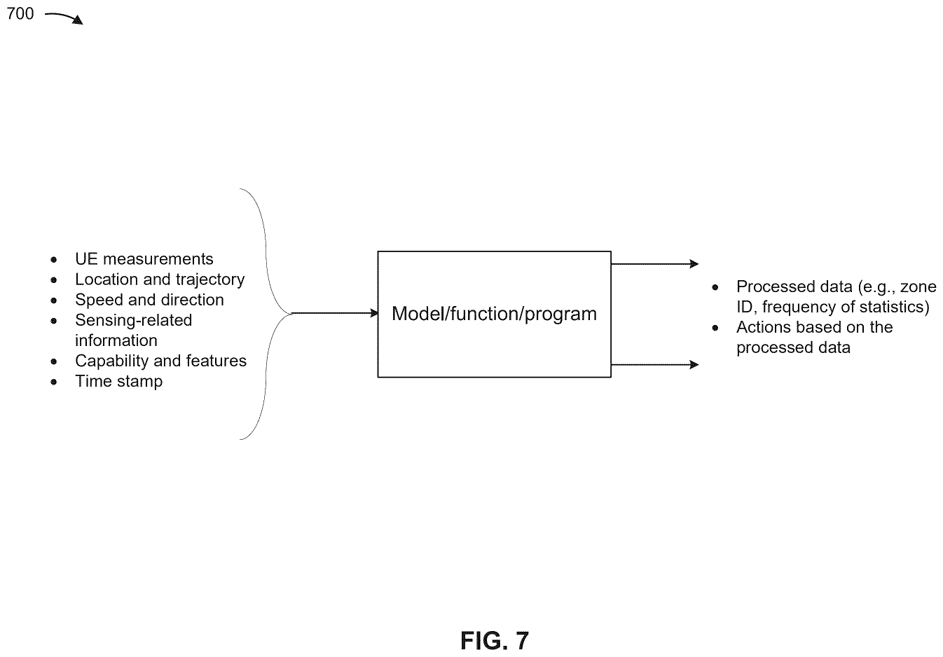

FIG. 7 is a diagram illustrating an example 700 associated with determining a zone, in accordance with the present disclosure.

In some aspects, the UE 520 may receive zone determination information for determining a zone of the UE 520. The zone determination may include information associated with an ML model, such as the ML model, an ML function for the ML model, or one or more parameters for the ML model. In some aspects, the zone determination information may include a function (e.g., addition function, logic) or a script (e.g., simple script or applet). Different UE types (e.g., RedCap) may have different functions. Some zone information may be transmitted using a small data transmission (SDT).

Example 700 shows that, for an ML model, a function, or a script, there may be one or more inputs and one or more outputs. Inputs may include, among other examples, UE measurements, a location of the UE, a trajectory of the UE, a speed of the UE, a direction of the UE, sensing-related information for the UE, a capability of the UE, features for the UE, and/or a timestamp. Outputs may include, among other examples, processed data (e.g., zone ID, frequency of statistics) and/or actions based at least in part on the processed data.

In some aspects, a message container may be defined or configured with an interface to support zone determinations. The network entity 510 or 515 may transmit zone determination information using a container. Zone determination may be associated with an expected UE behavior. Zone determination information may include a zone determination configuration that uses a list of possible input parameters.

As indicated above, FIG. 7 is provided as an example. Other examples may differ from what is described with respect to FIG. 7.

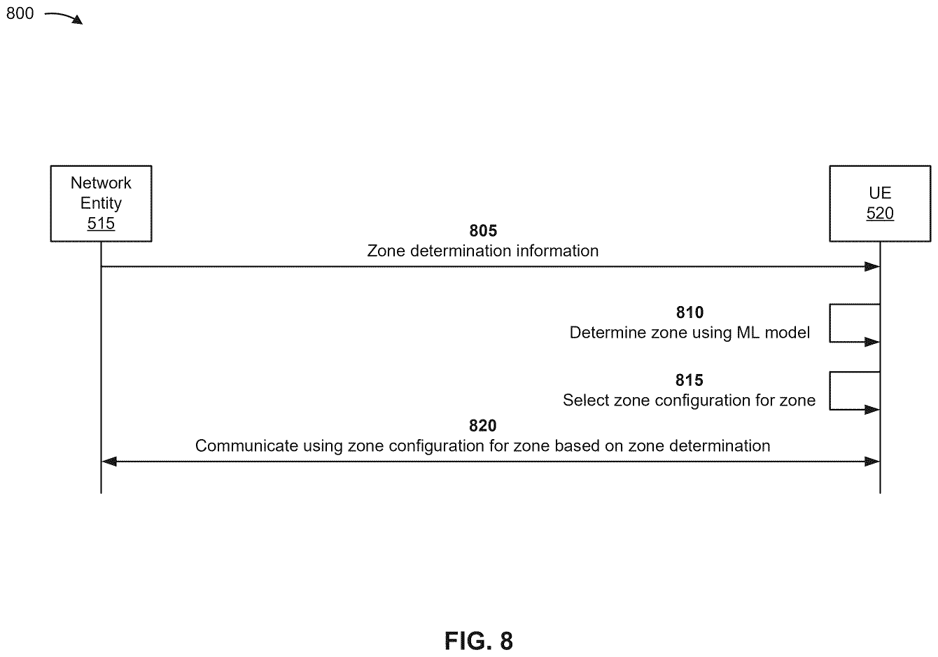

FIG. 8 is a diagram illustrating an example 800 of using zone determination information, in accordance with the present disclosure.

As shown by reference number 805, the network entity 515 may transmit zone determination information. The zone determination information may include an ML model, an ML function, a non-ML function, ML parameters, and/or a script. In example 800, the zone determination information may include an ML model, an ML function for the ML model, and/or ML parameters for the ML model. The ML model may be trained to identify a zone for which a zone configuration applies. In some aspects, the zone determination information may be specific to a UE type.

In some aspects, the ML model may be trained using a UE measurement, a UE location, a UE speed, or a UE direction as an input and a zone identifier as an output. In some aspects, the ML model may be trained using UE sensing measurements as an input and a zone identifier as an output. In some aspects, the ML model may be trained using UE mobility information as an input and a zone identifier as an output. In some aspects, the ML model may be trained using a UE feature, a UE capability, or a UE class as an input and a zone identifier as an output. The ML model may be trained using a UE feature or a UE capability as an input and a zone ID as an output. In some aspects, the zone determination information may be associated with one or more actions to be performed based at least in part on an output of the ML model.

As shown by reference number 810, the UE 520 may determine a zone of the UE using the ML model and the zone determination information. This may include using one or more inputs to the ML model, as described in connection with FIG. 7. As shown by reference number 815, the UE 520 may select a zone configuration for the zone (e.g., a zone-specific beam configuration or a broadcast monitoring configuration).

As shown by reference number 820, the UE 520 may communicate (e.g., transmit or receive) using the zone configuration, based at least in part on the zone determination. If the UE 520 determines the zone, the corresponding zone configuration is used. If the UE 520 does not successfully determine the zone, a default zone configuration may be used. By using a zone-specific configuration, the UE 520 may use a more optimal beam configuration or monitoring scheme to improve communications, which increases throughput and reduces latency.

As indicated above, FIG. 8 is provided as an example. Other examples may differ from what is described with respect to FIG. 8.

FIG. 9 is a flowchart of an example method 900 of wireless communication. The method 900 may be performed at, for example, a UE (e.g., UE 520) or an apparatus of a UE.

Method 900 begins at 910 with selecting a zone configuration for a zone that is specific to where signal measurements satisfy a signal threshold or where a signal timing satisfies a timing threshold. For example, the UE may select a zone configuration for a zone that is specific to where signal measurements satisfy a signal threshold or where a signal timing satisfies a timing threshold, as described above in connection with, for example, FIG. 5 and FIG. 6.

Method 900 then proceeds at 920 with communicating using the zone configuration based at least in part on a determination that the UE is located in the zone. For example, the UE may communicate using the zone configuration based at least in part on a determination that the UE is located in the zone, as described above in connection with, for example, FIG. 5 and FIG. 6.

In some aspects, the signal threshold includes a short-range wireless protocol signal threshold. In some aspects, the signal threshold includes a Wi-Fi signal threshold.

In some aspects, the timing characteristic is associated with a downlink receive timing or an uplink transmit timing. In some aspects, the timing characteristic is associated with an estimated round trip time.

In some aspects, the zone configuration is associated with a beam search, a cell search, a beam measurement, a cell measurement, a beam selection, or a cell selection.

In some aspects, the zone configuration is associated with a random access channel configuration, a paging configuration, a time adjustment, a power adjustment, a cell identifier hash, or a slot configuration.

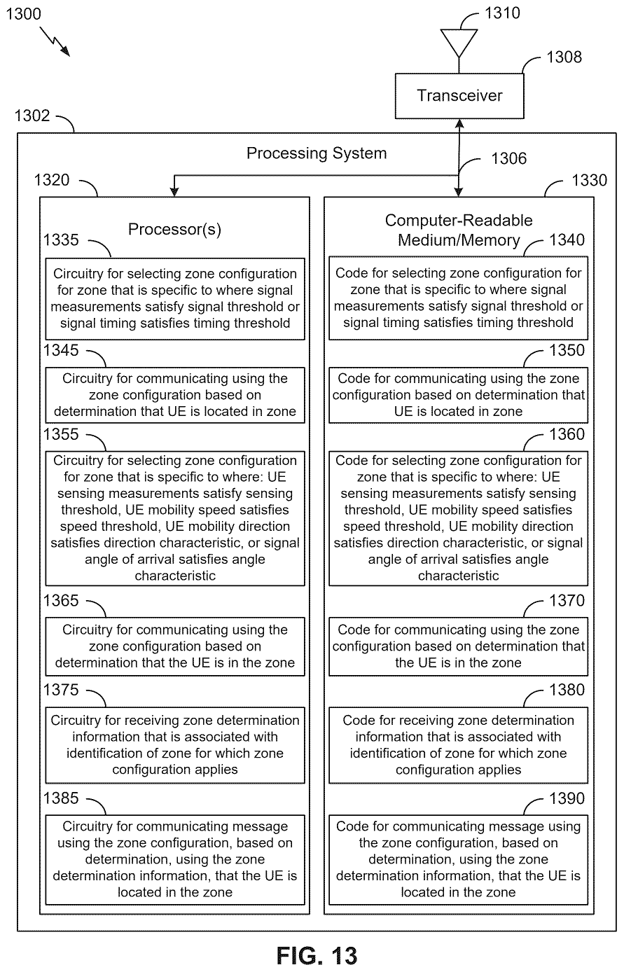

In one aspect, method 900, or any aspect related to it, may be performed by an apparatus, such as communications device 1300 of FIG. 13, which includes various components operable, configured, or adapted to perform the method 900. Communications device 1300 is described below in further detail.

Although FIG. 9 shows example blocks of method 900, in some aspects, method 900 may include additional blocks, fewer blocks, different blocks, or differently arranged blocks than those depicted in FIG. 9. Additionally, or alternatively, two or more of the blocks of method 900 may be performed in parallel.

FIG. 10 is a flowchart of an example method 1000 of wireless communication. The method 1000 may be performed at, for example, a UE (e.g., UE 520) or an apparatus of a UE.

Method 1000 begins at 1010 with selecting a zone configuration for a zone that is specific to where: UE sensing measurements satisfy a sensing threshold, a UE mobility speed satisfies a speed threshold, a UE mobility direction satisfies a direction characteristic, or a signal angle of arrival satisfies an angle characteristic. For example, the UE may select a zone configuration for a zone that is specific to where: UE sensing measurements satisfy a sensing threshold, a UE mobility speed satisfies a speed threshold, a UE mobility direction satisfies a direction characteristic, or a signal angle of arrival satisfies an angle characteristic, as described above in connection with, for example, FIG. 5 and FIG. 6.

Method 1000 then proceeds at 1020 with communicating using the zone configuration based at least in part on a determination that the UE is in the zone. For example, the UE may communicate using the zone configuration based at least in part on a determination that the UE is in the zone, as described above in connection with, for example, FIG. 5 and FIG. 6.

In some aspects, method 1000 includes selecting the zone configuration for the zone further based at least in part on a UE feature satisfying a feature characteristic, a UE class matching a UE class characteristic, a UE subscription matching a subscription characteristic, or a UE capability satisfying a UE capability characteristic.

In one aspect, method 1000, or any aspect related to it, may be performed by an apparatus, such as communications device 1300 of FIG. 13, which includes various components operable, configured, or adapted to perform the method 1000. Communications device 1300 is described below in further detail.

Although FIG. 10 shows example blocks of method 1000, in some aspects, method 1000 may include additional blocks, fewer blocks, different blocks, or differently arranged blocks than those depicted in FIG. 10. Additionally, or alternatively, two or more of the blocks of method 1000 may be performed in parallel.

FIG. 11 is a flowchart of an example method 1100 of wireless communication. The method 1100 may be performed at, for example, a UE (e.g., UE 520) or an apparatus of a UE.

Method 1100 begins at 1110 with receiving zone determination information that is associated with identification of a zone for which a zone configuration applies. For example, the UE may receive zone determination information that is associated with identification of a zone for which a zone configuration applies, as described above in connection with, for example, FIGS. 5-8.

Method 1100 then proceeds at 1120 with communicating a message using the zone configuration, based at least in part on a determination, using the zone determination information, that the UE is located in the zone. For example, the UE may communicate a message using the zone configuration, based at least in part on a determination, using the zone determination information, that the UE is located in the zone, as described above in connection with, for example, FIGS. 5-8.

In some aspects, the zone determination information includes a function for identification of the zone, one or more parameters for the function, a script for identification of the zone, or one or more parameters for the script.

In some aspects, the zone determination information includes an ML model that is trained to identify a zone for which a zone configuration applies, an ML function for the ML model, or one or more parameters for the ML model.

In some aspects, communicating the message includes communicating the message based at least in part on a determination, using the ML model and the zone determination information, that the UE is located in the zone.

In some aspects, the ML model is trained using a UE measurement, a UE location, a UE speed, or a UE direction as an input and a zone identifier as an output. In some aspects, the ML model is trained using UE sensing measurements as an input and a zone identifier as an output. In some aspects, the ML model is trained using UE mobility information as an input and a zone identifier as an output. In some aspects, the ML model is trained using a UE feature, a UE capability, or a UE class as an input and a zone identifier as an output. In some aspects, the ML model is trained using a UE feature or a UE capability as an input and a zone identifier as an output.

In some aspects, the zone determination information is specific to a UE type. In some aspects, the zone determination information is associated with one or more actions to be performed based at least in part on an output of the ML model.

In one aspect, method 1100, or any aspect related to it, may be performed by an apparatus, such as communications device 1300 of FIG. 13, which includes various components operable, configured, or adapted to perform the method 1100. Communications device 1300 is described below in further detail.

Although FIG. 11 shows example blocks of method 1100, in some aspects, method 1100 may include additional blocks, fewer blocks, different blocks, or differently arranged blocks than those depicted in FIG. 11. Additionally, or alternatively, two or more of the blocks of method 1100 may be performed in parallel.

FIG. 12 is a diagram of an example apparatus 1200 for wireless communication, in accordance with the present disclosure. The apparatus 1200 may be a UE (e.g., UE 520), or a UE may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 140 described in connection with FIG. 1) of the UE.

In some aspects, the apparatus 1200 may be configured to perform one or more operations described herein in connection with FIGS. 1-8. Additionally, or alternatively, the apparatus 1200 may be configured to perform one or more processes described herein, such as method 900 of FIG. 9, method 1000 of FIG. 10, method 1100 or FIG. 11, or a combination thereof. In some aspects, the apparatus 1200 and/or one or more components shown in FIG. 12 may include one or more components of the UE described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the UE described above in connection with FIG. 1, such as a radio, one or more RF chains, one or more transceivers, or one or more modems, each of which may in turn be coupled with one or more antennas of the UE.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1204 may be co-located with the reception component 1202.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

In some aspects, the communication manager 1206 may select a zone configuration for a zone that is specific to where signal measurements satisfy a signal threshold or where a signal timing satisfies a timing threshold. The reception component 1202 and/or the transmission component 1204 may communicate using the zone configuration based at least in part on a determination that the UE is located in the zone.

In some aspects, the communication manager 1206 may select a zone configuration for a zone that is specific to where: UE sensing measurements satisfy a sensing threshold, a UE mobility speed satisfies a speed threshold, a UE mobility direction satisfies a direction characteristic, or a signal angle of arrival satisfies an angle characteristic. The reception component 1202 and/or the transmission component 1204 may communicate using the zone configuration based at least in part on a determination that the UE is in the zone.

The communication manager 1206 may select the zone configuration for the zone further based at least in part on a UE feature satisfying a feature characteristic, a UE class matching a UE class characteristic, a UE subscription matching a subscription characteristic, or a UE capability satisfying a UE capability characteristic.

In some aspects, the reception component 1202 may receive zone determination information that is associated with identification of a zone for which a zone configuration applies. The reception component 1202 and/or the transmission component 1204 may communicate a message using the zone configuration, based at least in part on a determination, using the zone determination information, that the UE is located in the zone.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram illustrating an example of an implementation of code and circuitry for a communications device 1300, in accordance with the present disclosure. The communications device 1300 may be a UE (e.g., UE 120, UE 520), or a UE may include the communications device 1300.

The communications device 1300 includes a processing system 1302 coupled to a transceiver 1308 (e.g., a transmitter and/or a receiver, and which may include a single transceivers or multiple transceivers which may perform different operations described as being performed by the transceiver 1308). The processing system 1302 may be, or may be similar to, the processing system 140 of the UE 120. The transceiver 1308 is configured to transmit and receive signals for the communications device 1300 via an antenna 1310, such as the various signals as described herein. The processing system 1302 may be configured to perform processing functions for the communications device 1300, including processing signals received and/or to be transmitted by the communications device 1300.

The processing system 1302 includes one or more processors 1320. In various aspects, the one or more processors 1320 may include one or more of a receive processor, a transmit processor, a TX MIMO processor, and/or a controller/processor, among other examples, such as one or more processors described in connection with the processing system 140 of the UE 120. The one or more processors 1320 are coupled to a computer-readable medium/memory 1330 via a bus 1306. In various aspects, the computer-readable medium/memory 1330 may include one or more memories. In certain aspects, the computer-readable medium/memory 1330 is configured to store instructions (e.g., computer-executable code, processor-executable code) that when executed by the one or more processors 1320, cause the one or more processors 1320 to perform the method 600 described with respect to FIG. 6, or any aspect related to it. Note that reference to a processor performing a function of communications device 1300 may include one or more processors performing that function of communications device 1300. Note also that reference to one or more processors performing multiple functions may include a first processor performing a first function of the multiple functions and a second processor performing a second function of the multiple functions.

As shown in FIG. 13, the communications device 1300 may include circuitry for selecting a zone configuration for a zone that is specific to where signal measurements satisfy a signal threshold or where a signal timing satisfies a timing threshold (circuitry 1335).

As shown in FIG. 13, the communications device 1300 may include, stored in computer-readable medium/memory 1330, code for selecting a zone configuration for a zone that is specific to where signal measurements satisfy a signal threshold or where a signal timing satisfies a timing threshold (code 1340).

As shown in FIG. 13, the communications device 1300 may include circuitry for communicating using the zone configuration based at least in part on a determination that the UE is located in the zone (circuitry 1345).

As shown in FIG. 13, the communications device 1300 may include, stored in computer-readable medium/memory 1330, code for communicating using the zone configuration based at least in part on a determination that the UE is located in the zone (code 1350).

As shown in FIG. 13, the communications device 1300 may include circuitry for selecting a zone configuration for a zone that is specific to where: UE sensing measurements satisfy a sensing threshold, a UE mobility speed satisfies a speed threshold, a UE mobility direction satisfies a direction characteristic, or a signal angle of arrival satisfies an angle characteristic (circuitry 1355).

As shown in FIG. 13, the communications device 1300 may include, stored in computer-readable medium/memory 1330, code for selecting a zone configuration for a zone that is specific to where: UE sensing measurements satisfy a sensing threshold, a UE mobility speed satisfies a speed threshold, a UE mobility direction satisfies a direction characteristic, or a signal angle of arrival satisfies an angle characteristic (code 1360).

As shown in FIG. 13, the communications device 1300 may include circuitry for communicating using the zone configuration based at least in part on a determination that the UE is in the zone (circuitry 1365).

As shown in FIG. 13, the communications device 1300 may include, stored in computer-readable medium/memory 1330, code for communicating using the zone configuration based at least in part on a determination that the UE is in the zone (code 1370).

Various components of the communications device 1300 may provide means for performing the method 600 described with respect to FIG. 6, or any aspect related to it. For example, means for transmitting, sending, or outputting for transmission may include one or more components of the processing system 140 and/or the UE 120 (such as transceiver(s) and/or antenna(s) of the UE 120) and/or transceiver 1308 and antenna 1310 of the communications device 1300 in FIG. 13. Means for receiving or obtaining may include one or more components of the processing system 140 and/or the UE 120 (such as transceiver(s) and/or antenna(s) of the UE 120) and/or transceiver 1308 and antenna 1310 of the communications device 1300 in FIG. 13.

As shown in FIG. 13, the communications device 1300 may include circuitry for receiving zone determination information that is associated with identification of a zone for which a zone configuration applies (circuitry 1375).

As shown in FIG. 13, the communications device 1300 may include, stored in computer-readable medium/memory 1330, code for receiving zone determination information that is associated with identification of a zone for which a zone configuration applies (code 1380).

As shown in FIG. 13, the communications device 1300 may include circuitry for communicating a message using the zone configuration, based at least in part on a determination, using the zone determination information, that the UE is located in the zone (circuitry 1385).

As shown in FIG. 13, the communications device 1300 may include, stored in computer-readable medium/memory 1330, code for communicating a message using the zone configuration, based at least in part on a determination, using the zone determination information, that the UE is located in the zone (code 1390).

Various components of the communications device 1300 may provide means for performing the method 800 described with respect to FIG. 8, or any aspect related to it. For example, means for transmitting, sending, or outputting for transmission may include one or more components of the processing system 140 and/or the UE 120 (such as transceiver(s) and/or antenna(s) of the UE 120) and/or transceiver 1308 and antenna 1310 of the communications device 1300 in FIG. 13. Means for receiving or obtaining may include one or more components of the processing system 140 and/or the UE 120 (such as transceiver(s) and/or antenna(s) of the UE 120) and/or transceiver 1308 and antenna 1310 of the communications device 1300 in FIG. 13.

FIG. 13 is provided as an example. Other examples may differ from what is described in connection with FIG. 13.

The following provides an overview of some Aspects of the present disclosure:

Aspect 1: A method of wireless communication performed by a user equipment (UE), comprising: selecting a zone configuration for a zone that is specific to where signal measurements satisfy a signal threshold or where a signal timing satisfies a timing threshold; and communicating using the zone configuration based at least in part on a determination that the UE is located in the zone.

Aspect 2: The method of Aspect 1, wherein the signal threshold includes a short-range wireless protocol signal threshold.

Aspect 3: The method of any of Aspects 1-2, wherein the signal threshold includes a Wi-Fi signal threshold.

Aspect 4: The method of any of Aspects 1-3, wherein the timing characteristic is associated with a downlink receive timing or an uplink transmit timing.

Aspect 5: The method of any of Aspects 1-4, wherein the timing characteristic is associated with an estimated round trip time.

Aspect 6: The method of any of Aspects 1-5, wherein the zone configuration is associated with a beam search, a cell search, a beam measurement, a cell measurement, a beam selection, or a cell selection.

Aspect 7: The method of any of Aspects 1-6, wherein the zone configuration is associated with a random access channel configuration, a paging configuration, a time adjustment, a power adjustment, a cell identifier hash, or a slot configuration.

Aspect 8: A method of wireless communication performed by a user equipment (UE), comprising: selecting a zone configuration for a zone that is specific to where: UE sensing measurements satisfy a sensing threshold, a UE mobility speed satisfies a speed threshold, a UE mobility direction satisfies a direction characteristic, or a signal angle of arrival satisfies an angle characteristic; and communicating using the zone configuration based at least in part on a determination that the UE is in the zone.

Aspect 9: The method of Aspect 8, further comprising selecting the zone configuration for the zone further based at least in part on a UE feature satisfying a feature characteristic, a UE class matching a UE class characteristic, a UE subscription matching a subscription characteristic, or a UE capability satisfying a UE capability characteristic.

Aspect 10: A method of wireless communication performed by a user equipment (UE), comprising: receiving zone determination information that is associated with identification of a zone for which a zone configuration applies; and communicating a message using the zone configuration, based at least in part on a determination, using the zone determination information, that the UE is located in the zone.

Aspect 11: The method of Aspect 10, wherein the zone determination information includes a function for identification of the zone, one or more parameters for the function, a script for identification of the zone, or one or more parameters for the script.

Aspect 12: The method of any of Aspects 10-11, wherein the zone determination information includes an ML model that is trained to identify a zone for which a zone configuration applies, an ML function for the ML model, or one or more parameters for the ML model.

Aspect 13: The method of Aspect 12, wherein communicating the message includes communicating the message based at least in part on a determination, using the ML model and the zone determination information, that the UE is located in the zone.

Aspect 14: The method of Aspect 12, wherein the ML model is trained using a UE measurement, a UE location, a UE speed, or a UE direction as an input and a zone identifier as an output.

Aspect 15: The method of Aspect 12, wherein the ML model is trained using UE sensing measurements as an input and a zone identifier as an output.

Aspect 16: The method of Aspect 12, wherein the ML model is trained using UE mobility information as an input and a zone identifier as an output.

Aspect 17: The method of Aspect 12, wherein the ML model is trained using a UE feature, a UE capability, or a UE class as an input and a zone identifier as an output.

Aspect 18: The method of Aspect 12, wherein the ML model is trained using a UE feature or a UE capability as an input and a zone identifier as an output.

Aspect 19: The method of Aspect 12, wherein the zone determination information is specific to a UE type.

Aspect 20: The method of Aspect 12, wherein the zone determination information is associated with one or more actions to be performed based at least in part on an output of the ML model.

Aspect 21: A method of wireless communication performed by a network entity, comprising: transmitting zone determination information that is associated with identification of a zone for which a zone configuration applies; and communicating a message using the zone configuration.

Aspect 22: The method of Aspect 21, wherein the zone determination information includes a function for identification of the zone, one or more parameters for the function, a script for identification of the zone, or one or more parameters for the script.

Aspect 23: The method of any of Aspects 21-22, wherein the zone determination information includes an ML model that is trained to identify a zone for which a zone configuration applies, an ML function for the ML model, or one or more parameters for the ML model.

Aspect 24: The method of Aspect 23, wherein the ML model is trained using a UE measurement, a UE location, a UE speed, or a UE direction as an input and a zone identifier as an output.

Aspect 25: The method of Aspect 23, wherein the ML model is trained using UE sensing measurements as an input and a zone identifier as an output.

Aspect 26: The method of Aspect 23, wherein the ML model is trained using UE mobility information as an input and a zone identifier as an output.

Aspect 27: The method of Aspect 23, wherein the ML model is trained using a UE feature, a UE capability, or a UE class as an input and a zone identifier as an output.

Aspect 28: The method of Aspect 23, wherein the ML model is trained using a UE feature or a UE capability as an input and a zone identifier as an output.

Aspect 29: The method of Aspect 23, wherein the zone determination information is specific to a UE type.

Aspect 30: The method of Aspect 23, wherein the zone determination information is associated with one or more actions to be performed based at least in part on an output of the ML model.

Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-30.

Aspect 32: An apparatus for wireless communication at a device, the apparatus comprising one or more memories and one or more processors coupled to the one or more memories, the one or more processors configured to cause the device to perform the method of one or more of Aspects 1-30.

Aspect 33: An apparatus for wireless communication, the apparatus comprising at least one means for performing the method of one or more of Aspects 1-30.

Aspect 34: A non-transitory computer-readable medium storing code for wireless communication, the code comprising instructions executable by one or more processors to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

Aspect 36: A device for wireless communication, the device comprising a processing system that includes one or more processors and one or more memories coupled with the one or more processors, the processing system configured to cause the device to perform the method of one or more of Aspects 1-30.

Aspect 37: An apparatus for wireless communication at a device, the apparatus comprising one or more memories and one or more processors coupled to the one or more memories, the one or more processors individually or collectively configured to cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories comprising processor-executable instructions; and
one or more processors configured to execute the processor-executable instructions and cause the apparatus to:
select a zone configuration for a zone that is specific to where signal measurements satisfy a signal threshold or where a signal timing satisfies a timing threshold; and
communicate using the zone configuration based at least in part on a determination that the UE is located in the zone.

2. The apparatus of claim 1, wherein the signal threshold includes a short-range wireless protocol signal threshold.

3. The apparatus of claim 1, wherein the signal threshold includes a Wi-Fi signal threshold.

4. The apparatus of claim 1, wherein the timing characteristic is associated with a downlink receive timing or an uplink transmit timing.

5. The apparatus of claim 1, wherein the timing characteristic is associated with an estimated round trip time.

6. The apparatus of claim 1, wherein the zone configuration is associated with a beam search, a cell search, a beam measurement, a cell measurement, a beam selection, or a cell selection.

7. The apparatus of claim 1, wherein the zone configuration is associated with a random access channel configuration, a paging configuration, a time adjustment, a power adjustment, a cell identifier hash, or a slot configuration.

8. An apparatus for wireless communication at a user equipment (UE), comprising:
one or more memories comprising processor-executable instructions; and
one or more processors configured to execute the processor-executable instructions and cause the apparatus to:
select a zone configuration for a zone that is specific to where:
UE sensing measurements satisfy a sensing threshold,
a UE mobility speed satisfies a speed threshold,
a UE mobility direction satisfies a direction characteristic, or
a signal angle of arrival satisfies an angle characteristic; and communicate using the zone configuration based at least in part on a determination that the UE is in the zone.

9. The apparatus of claim 8, wherein the one or more processors are configured to cause the UE to select the zone configuration for the zone further based at least in part on a UE feature satisfying a feature characteristic, a UE class matching a UE class characteristic, a UE subscription matching a subscription characteristic, or a UE capability satisfying a UE capability characteristic.

10. An apparatus for wireless communication at a user equipment (UE), comprising:
one or more memories comprising processor-executable instructions; and
one or more processors configured to execute the processor-executable instructions and cause the apparatus to:
receive zone determination information that is associated with identification of a zone for which a zone configuration applies; and
communicate a message using the zone configuration, based at least in part on a determination, using the zone determination information, that the UE is located in the zone.

11. The apparatus of claim 10, wherein the zone determination information includes a function for identification of the zone, one or more parameters for the function, a script for identification of the zone, or one or more parameters for the script.

12. The apparatus of claim 10, wherein the zone determination information includes an ML model that is trained to identify a zone for which a zone configuration applies, an ML function for the ML model, or one or more parameters for the ML model.

13. The apparatus of claim 12, wherein to communicate the message, the one or more processors are configured to execute the processor-executable instructions and cause the apparatus to communicate the message based at least in part on a determination, using the ML model and the zone determination information, that the UE is located in the zone.

14. The apparatus of claim 12, wherein the ML model is trained using a UE measurement, a UE location, a UE speed, or a UE direction as an input and a zone identifier as an output.

15. The apparatus of claim 12, wherein the ML model is trained using UE sensing measurements as an input and a zone identifier as an output.

16. The apparatus of claim 12, wherein the ML model is trained using UE mobility information as an input and a zone identifier as an output.

17. The apparatus of claim 12, wherein the ML model is trained using a UE feature, a UE capability, or a UE class as an input and a zone identifier as an output.

18. The apparatus of claim 12, wherein the ML model is trained using a UE feature or a UE capability as an input and a zone identifier as an output.

19. The apparatus of claim 12, wherein the zone determination information is specific to a UE type.

20. The apparatus of claim 12, wherein the zone determination information is associated with one or more actions to be performed based at least in part on an output of the ML model.
